(19) United States
(12) Patent Application Publication
(10) Pub. No.: US 2007/0271146 A1
(43) Pub. Date: Nov. 22, 2007

(54) Method and apparatus for matching and/or coordinating shoes handbags and other consumer products

(75) Inventors: Jon C. Nordmark, Highlands Ranch, CO (US); Mike Frazzini, Aurora, CO (US); Anthony L. Reynolds, Denver, CO (US); Nancy Behrendt, Littleton, CO (US)

Correspondence Address: SHERIDAN ROSS PC, 1560 BROADWAY, SUITE 1200, DENVER, CO, 80202, US

(73) Assignee: eBags.com, Greenwood Village, CO (US)

(21) Appl. No.: 11/256,655

(22) Filed: Oct. 20, 2005

(51) Int. Cl. G06Q 30/00

(52) U.S. Cl. 705/26

(57) ABSTRACT

An on-line shopping system and method to provide coordinated items and ensembles including shoes, shirts, bags, and other consumer products is provided. Manufacturers determine ensembles of “relevant” items. The items and ensembles are presented to shoppers where they are able to provide feedback as to how “relevant” the items are in their opinion based on lifestyle, profession, use and other factors. Ensembles may be reorganized according to shopper feedback and customized for future shoppers having qualities in common with the shoppers who have already provided feedback.

### FIELD OF THE INVENTION

The present invention relates to an apparatus and method of coordinating and grouping consumer products according to manufacturer and customer recommendations and feedback.

### BACKGROUND OF THE INVENTION

When shopping for various items like handbags, shoes, clothes, and the like, shoppers often wish to determine whether the items they are considering to purchase will actually look good together. This determination involves the colors and textures of the products as well as the style, size, shape, and so on. The process of determining if products actually go together is made more difficult by the fact that there are literally thousand of combinations of products that a shopper might consider. In the case of brick and mortar stores, the problem for the shopper is that the products they want to compare are rarely located in the same store. To complicate the issue, the different stores having products that the shopper desires may not even be located in the same geographical region. There is not a practical way for a shopper to ascertain where they should go to find the products that would constitute the best ensemble to meet their particular needs. Even if they could determine where to go, it may be very time consuming and costly to travel to all of the potential locations to view the products they are interested in. Additionally, it is extremely difficult for the shopper to put the various potential pieces of an ensemble together. A shopper could purchase all of the candidate pieces of an ensemble and put them together at home, but what happens if the products do not coordinate or match as the shopper intended? The shopper would have to return the non-matching items to the various retail stores where they were purchased. This process is so time consuming and costly that it is impractical for a vast majority of the consuming public to engage in these actions.

It is also often difficult for an e-commerce shopper to find relevant product offerings, as well as relevant product ensembles, or groups of products that complement each other. The problem is compounded by the fact that there are literally millions of travel or fashion accessories that an e-commerce shopper might consider.

Current classification systems are inefficient in addressing this problem because they are irrelevant, static, and inflexible. Furthermore, they do not utilize information known or provided by the shopper to effectively and efficiently direct them to relevant products and ensemble groups of complimentary products. Currently, classification schemes on Internet e-commerce sites are created and managed by professional merchandisers. While these schemes may be somewhat accurate or relevant for one shopper, they rely solely on the knowledge and experience of one individual to be relevant for a diverse community of shoppers.

Accordingly, a need exists to allow shoppers to conveniently and cost effectively view a large number of potential ensembles without visiting actual brick and mortar retail locations. Further, a need exists to help shoppers create potential ensembles out of the virtually limitless number of possibilities that could be assembled. Also, a need exists to allow shoppers to modify potential ensembles by substituting products then compare and contrast their selections before making a buying decision. Additionally, a need exists to allow shoppers to benefit from the collective opinions of many shoppers as to which ensembles may suit them the best.

### SUMMARY OF THE INVENTION

It is thus one aspect of the present invention to utilize existing Internet web technology including, hyperlinks, user interfaces, databases, and data storage technology to create a method and apparatus that optimizes the relevance, flexibility, and information that allows shoppers to find the most relevant item offerings and item ensembles.

In one embodiment of the present invention, the relevance of item offerings and item ensembles is optimized by allowing shoppers to create, manage, and navigate through their own classification schemes that are based on language, definitions, and terms that they are most familiar with. Initially, classification schemes are created and managed by manufactures of the items. Then shoppers are enabled to create and manage their own classification schemes and navigation, as well as drawing on the most relevant of classifications and navigations created by a diverse community of other shoppers. The classification schemes that were initially created by the manufacturer are adapted according to feedback retrieved from shoppers. Thus, a more dynamic and flexible classification scheme is created.

In another embodiment of the present invention, a method for creating an ensemble to be displayed on an e-commerce site is provided. Specifically, the method includes the steps of receiving a request to display a first product. Attributes of the first product are determined and then the first product is displayed to a shopper. A set of candidate products is searched and analyzed in order to find a most relevant product for the first product. The most relevant product has the most attributes in common with the first product compared to all other products of the set of candidate products. Then the most candidate product is displayed along with the first product. Various equations or algorithms can be applied in order to determine what is in fact the most relevant product. The first product may have more than one most relevant product if the algorithms used determine that more than one product has the same relevance. Algorithms can be adjusted and customized depending upon characteristics of the shopper who requested to view the first product.

In accordance with embodiments of the present invention, information known and/or provided by a first shopper to effectively and efficiently direct themselves to relevant items and ensembles may be utilized by other shoppers sharing common characteristics with the first shopper. By allowing shoppers to naturally identify with identical or similar shoppers and/or groups of shoppers with common product taste, shoppers can more efficiently look at ensembles that someone else has put together and feel confident that the items will in fact coordinate when they are received. Essentially the shopper is taking advice from someone with common characteristics that has already approved of the item, ensemble, and/or group of items.

In accordance with embodiments of the present invention, a method for coordinating items for display as ensembles is provided. In particular the method comprises, providing a first ensemble comprising a first set of items. As can be appreciated, the first set of items may simply be a single item. However, as more items are incorporated into a given ensemble, increased efficiency from use of the methods and apparatus disclosed is realized. Thereafter, characteristics of a first and second shopper are determined. The first shopper then reviews the first ensemble and determines how he/she feels about the ensemble. For example, the first shopper may feel that several of the items in the first ensemble do go together, but others may not fit their taste. The first shopper then provides their feedback relating to the first ensemble. Feedback can be in the form of tags, votes, ratings, and/or purchases of items by the shopper. They may have added items to the ensemble that they felt fit with the other items better and taken other items out that they felt did not belong. After they have provided feedback and changed the ensemble to fit their tastes essentially a second ensemble is created that is made up of potentially different items. Then, if the second shopper has similar characteristics to those of the first shopper, the second shopper can view and customize the second ensemble created by the first shopper. The second shopper may also view the first ensemble and customize it to his/her liking. The process may continue and ensembles that relate to a given shopper characteristic or taste may become more defined. Various ensembles created and edited by each shopper then develop over time as more and more shoppers review and edit each ensemble.

In accordance with embodiments of the present invention, surveys used to gain feedback and categorize shoppers are administered via email correspondence and the like. Specifically, shoppers may choose to be a part of the particular Internet e-commerce site's email program. Shoppers that have opted to participate may receive emails containing surveys about various items and ensembles. Shoppers then indicate on the surveys their interests in certain trends or styles of items and ensembles. For example, shoppers could be asked questions about the latest style. Questions on the surveys may include whether the shopper intends to buy the latest style, whether they would like to hear about the latest style, what they think about the latest style, etc. Based on the shopper's answers, characteristics of the shopper are updated accordingly. Shoppers could be categorized as always liking the latest styles or maybe classified as more traditional. Future email surveys could be targeted to various shoppers in the future based on feedback received from the shoppers.

It is still another aspect of the present invention to provide geographic information linked with product information in order to allow shoppers to navigate products by locations where they have been used by other customers as well as by other attributes. Shoppers interested in purchasing travel products for a vacation or business trip would like to be confident in the product they are buying because travel products can sometimes make or break a trip. In accordance with embodiments of the present invention, if someone is going to a particular location and they are interested buying carry on luggage, they could simply select that location (i.e., New York City) on a map and other customer's feedback related to New York City and the types of products they used there (including carry on luggage) can be viewed. Shoppers can review feedback provided by other customers related to how the trip was and what activities they performed. Specifically, the shopper may be interested in knowing what types of products were used during various activities. Information related to products and locations can be linked thereby allowing shoppers to navigate various products based on geographic information.

In accordance with another embodiment of the present invention, information gathered related to a particular shopper is stored and used to categorize the shopper into a group. The information can also be used to track buying habits and subsequently tastes and preferences that the shopper has. Information gathered (e.g., attributes, behaviors, and other characteristics) for a shopper based on his/her previous visits to the Internet e-commerce site can be used to customize advertisements displayed to the shopper in subsequent visits. Additionally, the shopper may be selectively put into contact with other vendors that might have something the shopper would be interested in including but not limited to consumer products, vacation locations, food and restaurants, entertainment, etc. Customized ad space can be sold at a premium because vendors will know that their advertisement is reaching their target audience. Furthermore, accurate feedback can be provided to the vendor allowing them to customize the next advertisement they create for a given Internet e-commerce site.

Thus, in one aspect of the present invention, a method for coordinating ensembles of consumer products for purchase on an e-commerce site is provided. The method comprising providing a first set of items, determining characteristics of a first and second shopper, receiving feedback from the first shopper relating to some items from the first set of items. Then in response to the feedback of the first shopper, creating a second set of items and displaying at least one item from the second set of items to the second shopper in response to determining that certain criteria of the first and second shopper are similar.

In another embodiment of the present invention, a method for creating an ensemble of consumer goods or information to be displayed on an e-commerce site is provided. The method comprising the steps of receiving a request to display a first product, determining attributes of the first product, and displaying the first product. Then from a first set of candidate products, finding a most relevant product, where the most relevant product has more attributes in common with the first product than any other product from the first set of candidate products. Once the most relevant product is found, it is then displayed with the first product.

These and other advantages will be apparent from the disclosure of the invention(s) contained herein. The above-described embodiments and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 is a block diagram depicting a shopping network in accordance with embodiments of the present invention;

FIG. 2 is a block diagram depicting item organization in accordance with embodiments of the present invention;

FIG. 3 is a block diagram depicting item properties and the related allocation of memory in accordance with embodiments of the present invention;

FIG. 4 is a block diagram depicting shopper grouping and organization in accordance with embodiments of the present invention;

FIG. 5 is a flow chart depicting aspects of shopper and item categorization and grouping in accordance with embodiments of the present;

FIG. 6 is a flow chart depicting the creation of tags and monitoring capabilities of a server in accordance with embodiments of the present invention;

FIG. 7 is a flow chart depicting the creation and usage of geocoded data in accordance with embodiments of the present invention; and

FIG. 8 is a flow chart depicting a method used to determine product relevance in accordance with embodiments of the present invention.

### DETAILED DESCRIPTION

The present invention is directed generally to a method and apparatus for use in item categorization and grouping. Also, the present invention is directed toward a method of grouping shoppers according to various determined characteristics in order to increase shopping satisfaction and decrease uncertainty related to e-shopping.

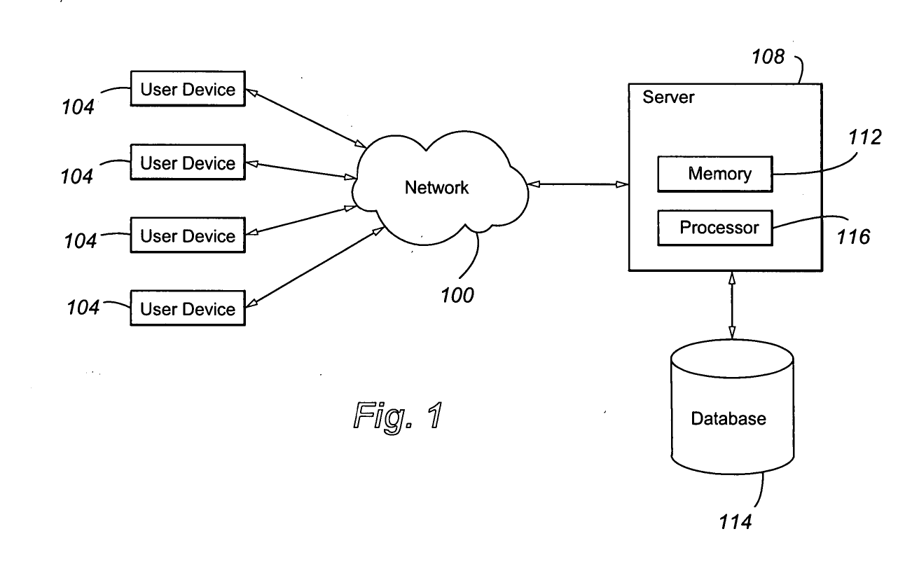

With reference initially to FIG. 1, a network 100 of shoppers will be discussed in accordance with embodiments of the present invention. User devices 104 are operable to communicate via the network 100 with a server 108. The server 108 includes a memory 112 and a processor 116. The server 108 may be owned and/or operated by a corresponding online shopping provider or enterprise like a merchant of one type of item or a retailer who sells a number of different products and product lines. The system depicts four user devices 104 for the purposes of illustration only. As can be appreciated by one of skill in the art, any number of user devices 104 may be connected to the network 100 through the Internet or an intranet. Furthermore, the connections between the user devices 104 and the network can be either wired or wireless connections and communications between the user devices 104 and the network 100 can follow any known protocols, for example, Transmission Control Protocol/Internet Protocol (TCP/IP). Examples of user devices 104 for interacting with server 108 include personal computers, laptop computers, notebook computers, palm top computers, network computers, or any processor-controlled device capable of executing a web browser or other type of application for interacting with the network 100.

The server 108 is connected to a database 114. The database 114 stores information related to shoppers who have accessed the server 108 to purchase or browse the items offered by the company. Additionally, information relating to items, groups and ensembles of items is stored in the database 1 14. As can be appreciated, the database 114 can also be integral to the server 108 rather than separate from the server 108 as depicted in FIG. 1.

Information relating to shopper and product attributes could also be stored in memory 112. Also included in the memory 112 of the server 108 are executable functions and routines. Furthermore memory 112 may include readable and writeable memory locations, examples of which include, Read Only Memory (ROM), Random Access Memory (RAM), any form of Programmable ROM (PROM), Static RAM (SRAM), Dynamic RAM (DRAM), and the like. The processor 116 executes commands given and stored by the memory 112.

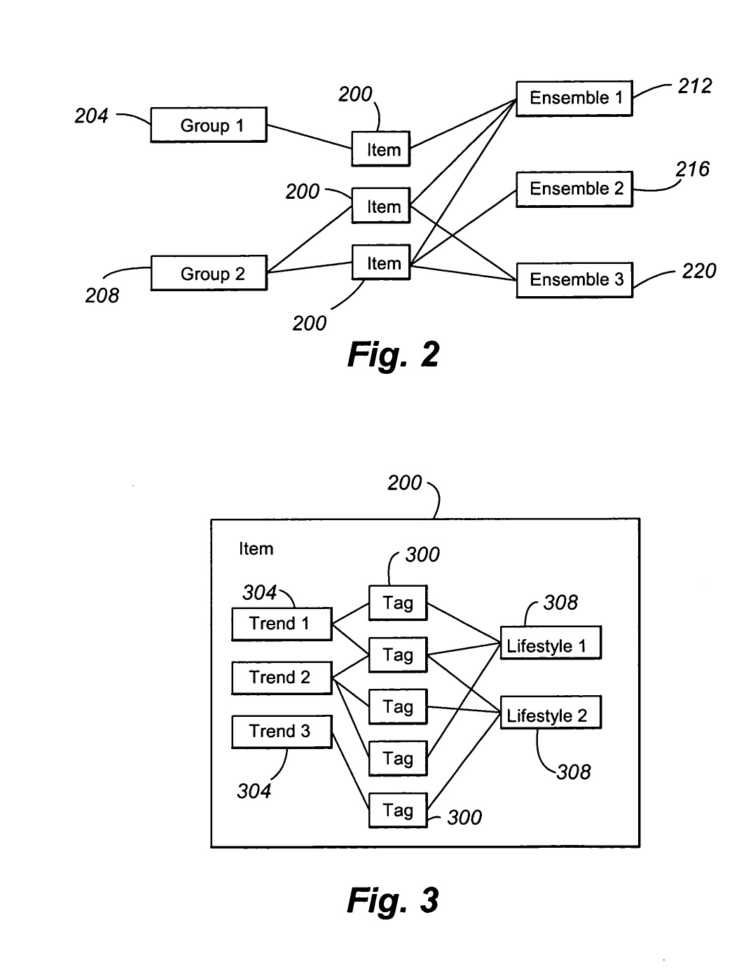

With reference to FIG. 2 the logical grouping of items 200 will be discussed in accordance with embodiments of the present invention. Information relating to the connections and logical groupings of items 200 is typically stored in the database 114. In one embodiment, a table (not shown) is used to maintain each item, ensemble, and group offered by a particular enterprise. Dynamic pointers and/or hyperlinks are created to connect various items, groups, and ensembles together in order to display an ordered set of items to a shopper. As used herein, an item 200 refers to any manufactured good that is being displayed and/or offered for sale by a particular enterprise. Groups 204 and 208 comprise different sets of items 200. For example, the first group 204 may correspond to shoes or footwear. Any item 200 that belongs to the first group 204 is somehow related to footwear. The second group 208 may correspond to handbags or personal carrying devices. Any item 200 that belongs to the second group 208 may relate to carrying devices in general. Each group may be divided into sub-groups corresponding to a more specified set of items within the original group. For instance, sub-groups within the first group 204 may be athletic shoes, dress shoes, casual shoes, socks, and the like. The same scenario may apply to the second group 208. Items 200 may be a part of one or more groups and/or sub-groups. Depending upon what types of properties define a particular item, a single item 200 may be part of a number of groups.

Items 200 are grouped into coordinating ensembles 212, 216, and 220. As can be appreciated, any number of items 200 and ensembles are possible. An ensemble may include only one item 200, but generally more than one item 200 define an ensemble. Ensembles are predetermined by a manufacturer or the enterprise selling the items in order to provide shoppers with an idea of how coordinating items 200 can go together. The relevance of items 200 is initially determined by the enterprise or manufacturer, but through the use of tags and the creation of dynamic pointers between items and ensembles, the relevance of items 200 may be redefined to provide customized ensembles and shopping experiences. Groups or sub-groups may also be a part of ensembles, however, the incorporation of individual items into ensembles provides a more personalized ensemble. As shown in FIG. 2, one item may be a part of only one ensemble. Alternatively, other items may be a part of many ensembles. Typically, items that are versatile like a brown purse can go with many other items, whereas a pair of hot pink and orange cowboy boots may not belong to as many ensembles. As will be described later, some items may be versatile (relevant) for a particular type of shopper and thus will belong to many ensembles for that shopper type, but will not be versatile for another type of shopper and therefore that same item may not belong to as many ensembles for that particular shopper type.

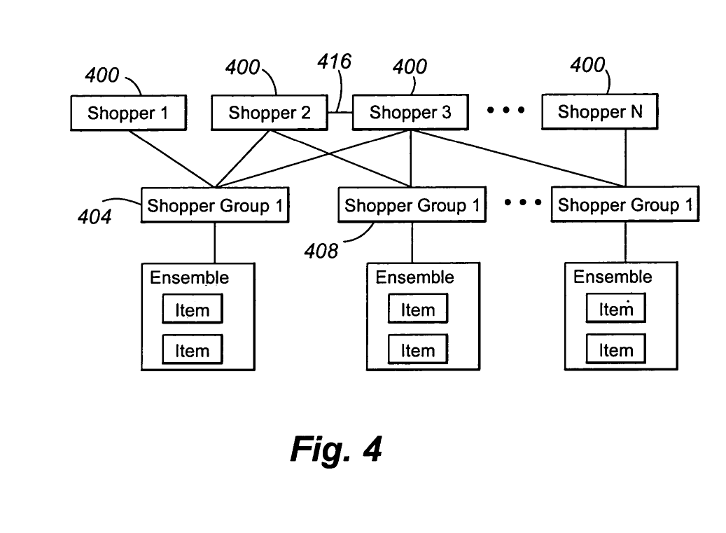

Referring now to FIG. 3, the use of tags to customize items and ensembles will be discussed in accordance with embodiments of the present invention. Shoppers apply a tag 300 to interesting products (e.g., items, ensembles, groups of items, and/or groups of ensembles) with keywords of their own choosing, which are based on language, definitions, and terms that are most familiar to them. The tags 300 are stored in memory 112 and/or the database 114 and are linked (e.g., through hyperlinks) to the product that it was applied to. Shoppers can use the same tag 300 to define many different products. Tags 300 typically are used to define products that the shopper found interesting to them, however, tags 300 may also be applied to a product to define negative characteristics of that particular product. Shoppers group their tags 300 into trends 304 and lifestyles 308. Both the trends 304 and lifestyles 308 provide a higher level of organization and classification for each product. Like tags 300, the trends 304 and lifestyles 308 are stored in the memory 112 and/or database 114 and are linked to the product to which they were applied. The links created between the tags 300, trends 304, and/or lifestyles 308 allow the shopper to access associated products (e.g., items, groups of items, ensembles, and the like) that have common qualities with the tagged product. Shoppers navigate to interesting and relevant items and ensembles offered by the enterprise through the tags 300, trends 304, and lifestyles 308 that they previously created. A tag 300 may belong to any number of trends 304 or lifestyle 308 categories. Alternatively, a tag 300 does not need to be grouped into any higher level of organization. Additionally, a shopper does not have to apply tags to items in order to access relevant products. The shopper may simply utilize tags created by other shoppers that he/she would apply to the product. Thus, the shopper benefits from the research and experience of previous shoppers that have common characteristics and taste.

With reference now to FIG. 4 the categorization and grouping of shoppers 400 will be described in accordance with embodiments of the present invention. Shoppers 400 create profiles, which contain key attributes that describe themselves and allow them to be linked with other shoppers 400 and/or shopper groups 404 having similar attributes. Possible attributes of a shopper 400 and shopper group 404 include, for example, gender, occupation, family information, age, favorite activities, marital status, etc. Additionally, shopper 400 behavior can be monitored and logged by the server 108. Shopper 400 behavior can include, votes logged relating to items, items purchased, item ratings, testimonials, blog entries, tags, and the like. Both attributes and behaviors are stored in the memory 112 and/or database 114. Each shopper 400 has their own set of attributes and behaviors that are dynamically updated as they continue to purchase or view items on a given website. As activities or transactions are logged and recorded by the memory 112 and/or database 114, new information is added to a shopper's 400 identity. Typically, characteristics like a shopper's 400 attributes are provided by the shopper 400 to the server 108, while characteristics like a shopper's 400 behaviors are monitored by the server 108 as activities or transactions take place on a particular Internet e-commerce location.

A shopper's 400 characteristics (e.g., attributes and behaviors) are used to link that shopper 400 to other shoppers with similar characteristics. A shopper 400 can choose to follow links relating to their attributes or behaviors depending on what type of item they are searching for. For example, with reference to FIG. 4, a first shopper 400 may associate his/herself with a first shopper group 404. Other shoppers having similar characteristics to those of the first shopper 400 are also able to join the first shopper group 404. The first shopper group 404 is defined by characteristics that each member of the group has in common. For example, the first shopper group 404 may be a group for professional businesswomen. Female shoppers that either work or prefer to wear business attire are a part of the first group 404 and relevant products are accessed by this particular group. Every shopper 400 benefits from the collective input of all other shoppers in the first shopper group 404. When one shopper 400 receives a number of items and provides feedback to the server 108, that information is cataloged and attached to the profile associated with the first shopper group.

Shoppers 400 can associate themselves with more than one shopper group. For instance, a shopper 400 who was a part of the first shopper group 404 may also be a part of a second shopper group 408. The second shopper group may be a group of outdoor enthusiast women. A woman may wear business attire during the weekdays at work, whereas on the weekends she wears outdoor attire. This particular woman may be a part of the first and second shoppers groups 404 and 408 respectively. Since she is associated with each of these groups, she is able to quickly and efficiently peruse ensembles that were created for and refined by each of these groups.

As more and more shoppers engage in shopping activities on a given Internet e-commerce site, the likelihood of two shoppers having nearly identical characteristics increases. Shoppers can associate themselves with other shoppers just as they associated themselves with shopper groups. The direct link 416 provides a way for shoppers to directly access products that another shopper has identified as a good item or set of items.

Once linked with other shoppers and shopper groups, shoppers can publish and share their own tags 300, trends 304, and lifestyles 308. Furthermore, they can access other shopper's tags, trends, and lifestyles to more effectively and efficiently navigate relevant items, groups of items, and ensembles. The tags 300, trends 304, and lifestyles 308 all have key attributes of relevance, which is a measure, stored and updated in the memory 112, of how many other shoppers and shopper groups have created and used matching or similar tags, trends, and lifestyles. These relevance metrics can also be accessed by shoppers, providing a method for prioritizing and optimizing their access to relevant articles like tags, trends, and lifestyles. Using these relevant articles provides shoppers a vehicle to navigate products that have been customized to their taste and characteristics. As shoppers view more relevant products they continue to add tags, trends, and lifestyles to those products for use by other shoppers. The database then refines ensembles and articles for various groups and types of shoppers using tags, trends, and lifestyles created by a shopper coupled with his/her characteristics.

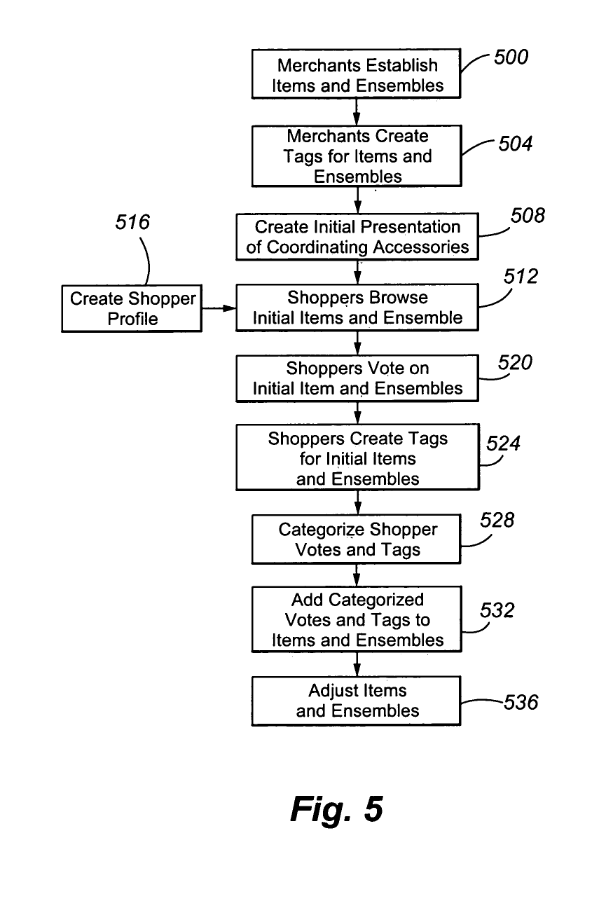

With reference to FIG. 5, details of the shopping and data gathering process will be described in accordance with embodiments of the present invention. In step 500, merchants establish items, groups, and ensembles (i.e. products). The merchant then creates tags or other types of identification for the products in step 504. The merchant created tags may be general tags that plainly define an item, group, or ensemble. For example, merchants may tag an item with “brown” and “purse” to simply indicate that the item is a brown purse. As many other items are created and tagged they are coordinated and matched with other items to create initial ensembles as determined by the merchant in step 508.

The shoppers are allowed to view items individually or may elect to view ensembles that have been created by the merchants in step 512. Typically, items are viewed over the Internet via a web browser or the like. Items can be quickly scrolled through and matched with other accessories in order to easily determine if items might coordinate. In step 516, the shopper creates a profile that describes themselves. Shopper profiles are initially created using attributes. As can be appreciated, shopper profiles may be created after several actions have taken place (e.g., items have been purchased, voted on, or tagged). In this event, the shopper profile is initially created with behaviors logged by the server rather than attributes that are created by the shopper. However, it is preferable to create shopper profiles through the use of attributes so that tags are categorized depending on what type of shopper created them.

As shoppers continue to browse they can vote, apply tags, or rate various products in step 524. The server then takes those tags and categorizes them according to the profile of the shopper who created them in step 528. These categorized tags can be grouped into trends and/or lifestyles as described above then added to the respective product in step 532. Tags are added to the products and the like through the use of hyperlinks, in accordance with one embodiment of the present invention. The links allow shoppers to browse those items through the use of the tag hyperlinks. Additionally, the shopper who created the tag can use the link created by the tag to see all the other items that he/she has previously applied the same tag to. In step 536, as votes, tags, and ratings accumulate and are categorized by the server, ensembles are adjusted and products browsed by various shoppers are personalized to those shoppers depending on their characteristics.

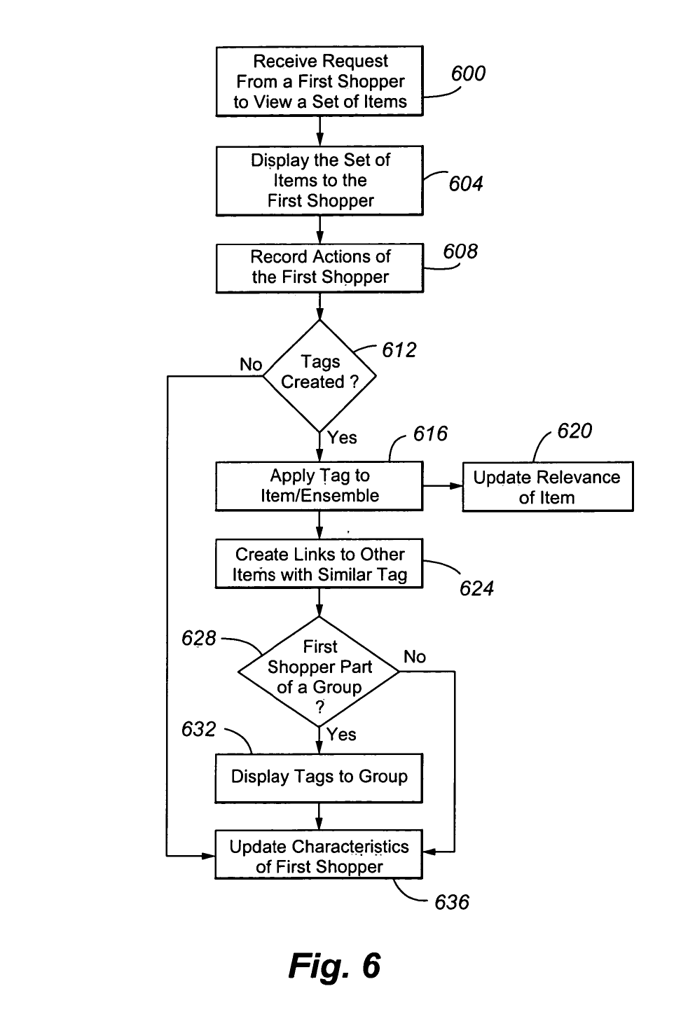

Referring now to FIG. 6, the creation of tags and monitoring of shopper activity will be described in accordance with embodiments of the present invention. In step 600 a request to view a set of items is received by the server 108 from a first shopper. The server retrieves the set of items from either it's memory 112 or from the database 114 then displays the set of items on a display screen of the user device 104 to the first shopper in step 604. The first shopper is then able to browse the set of items, and as he/she does so, the actions of the first shopper are recorded by the server 108. The different actions that are recorded can include votes on products, rankings of products, clicks on products, tags applied to products, and the like. It is determined in step 612 if a tag was one of those actions performed by the first shopper. If a tag was created then the tag is applied (e.g., by a pointer, hyperlink, etc.) to the product in step 616. As tags are applied to a given product, the relevance of that product is updated in step 620. Relevance is a measure of the number of shoppers and shopper groups who create and use a given tag or trend and is a key attribute of tags and trends. In step 624, links are created between the tag and other products with a similar tag. For example, if a first item was tagged as “Pretty Sweater”, then other products (e.g., items, ensembles, groups of items, etc.) that have been tagged as either “pretty” or “sweater” may be linked with the “Pretty Sweater” tag. This allows anyone to view the first item by clicking on the hyperlink for the tag “Pretty Sweater”. In step 628, the server determines if the first shopper was a part of any groups on the Internet e-commerce site. If the first shopper was a part of any group, then the tags that were created by the first shopper are displayed to the other members of the group in step 632. When the action is completed, whether it was a tag, vote, click, blog entry, rating, or the like, the characteristics of the first shopper are updated in step 636.

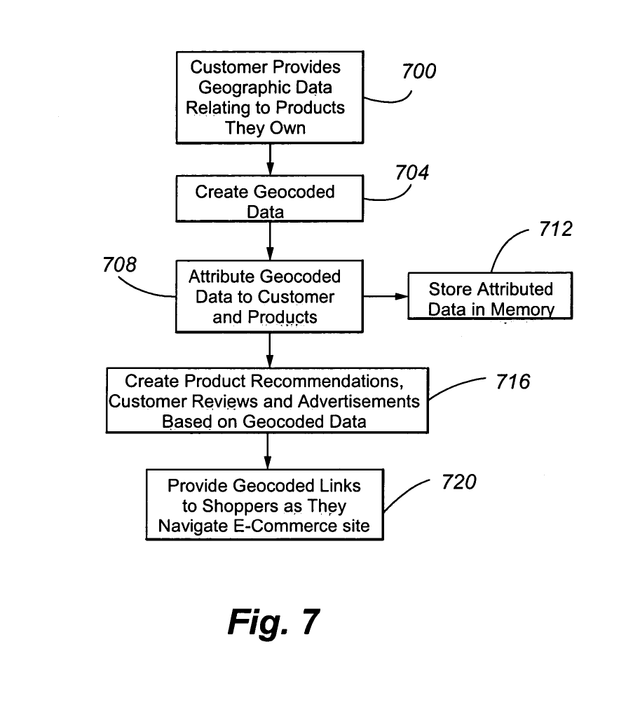

With reference to FIG. 7, an alternative method of customizing the shopping experience of a customer will be described in accordance with embodiments of the present invention. In particular, a shopper and/or previous customer is invited to review a product via email, on a website, or through some other type of survey. The survey has questions directed toward a product that the customer may own. Questions are also directed toward the geography of where a particular product was purchased and/or used. Of particular interest is where and how former customers have used travel products. In step 700 a customer provides feedback in the form of geographic data relating to products they own. Geographic data may include locations that a particular product has been taken to, if the product was useful in that location, whether the shopper needed the product in that location, etc. In one embodiment of the present invention, the customer is presented with a map and they indicate on the map any location that they have taken a particular product to. The customer may also provide feedback about a particular location in the form of describing the trip, uploading photos and videos, or creating a list of products that they brought with them to a particular location. Once the customer has provided feedback, relating products to a particular location, geocoded data is created in step 704. Geocoded data is created like a tag, as described above, in that a link is created between a given product and the location that it has been associated with through the customer feedback. The link allows other shoppers to view products based on locations or vice versa. In step 708, the geocoded data is attributed to the customer who provided feedback. In other words the geocoded data is added to the characteristics of the customer. The geocoded data is also attributed to the product that it was applied to, much like a tag. In step 712, the attributes, links and other pieces of information are stored in the memory 112 and/or the database 114. Other shoppers who are planning a trip to a particular location use the geocoded data to determine what type of products they should purchase. Product recommendations, customer reviews, and advertisements based on the geocoded data are created in step 716. Shoppers (both ones who created the geocoded data and others who did not) are provided with the geocoded links to navigate various products that have been associated with different locations.

The geocoded links are particularly useful when a shopper is planning a trip to a destination they have not visited before. The shopper can benefit from the experience of other customers who have been to that destination and have provided feedback about what types of products they used most often. Usage and activity data can also be collected from customers based on locations they have visited and products they have used there. The usage and activity data provides shoppers another way to browse products based on a geographic location. Navigation can be based not just on how many times someone has taken a product to a particular location, but also how it was used and for what types of activities. For example, products that are commonly brought on the same trip with other products may share geographic associations with those products and may gain a higher rank for that particular geographic location. Also, a shopper may choose to see which products were taken skiing in Vail, Colo. versus what products were taken fishing in Vail, Colo. by browsing based on activity.

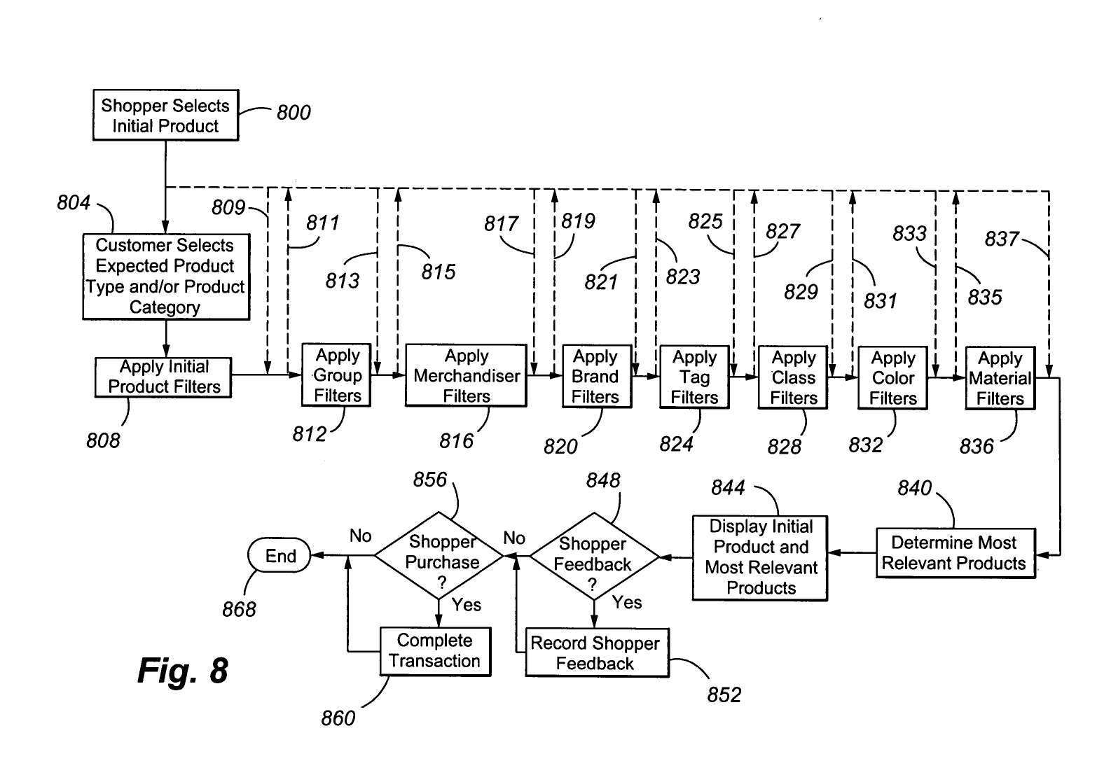

Referring now to FIG. 8, methods used to enhance a shopper's experience with a particular enterprise will be discussed in accordance with embodiments of the present invention. In step 800, a shopper selects an initial product. Typically the initial product is a single item, however, the initial product may also be a group of items or an ensemble depending upon the preferences of the shopper. Upon completion of step 800, multiple filters and/or grouping sub-algorithms are available to group and determine relevant products for the initial selected product as discussed below in reference to steps 804, 808, 812, 816, 820, 824, 828, 832, and 836. Any combination of the steps can be performed in any order. When a shopper does not wish to perform a particular filter step, or does not have the necessary characteristics to perform a filter step, that filter step may be skipped using optional links 809, 811, 813, 815, 817, 819, 821, 823, 825, 827, 829, 831, 833, 835, and 837. As can be appreciated optional link 837 may be used to bypass all filtering steps. Bypassing all filtering steps will result in no categorization or determination of a true relevant product for a selected product. However, “relevant” products may be determined based upon best selling products or other predetermined algorithms within the memory 112 of the server 108.

Assuming that the shopper wishes to select expected product types or product categories to be displayed with the selected product, step 804 is performed. By selecting at least one of expected product types and categories, a shopper is able to narrow down the field of search for relevant products. For example, if the shopper initially selected a pair of shoes and wants a matching bag, the shopper selects the bag product type to ensure that relevant products are actually bags. The shopper could further narrow down the product search by selecting what category of bag they wanted (e.g., handbag, briefcase, work-out bag, carry-on bag, etc.) The shopper could also select the product type to be the same product type as the selected product. In other words, the shopper may initially select a first pair of shoes, and could choose to view other pairs of relevant shoes. After the shopper has selected at least one of expected product type and category, initial product filters are applied in step 808. The initial filter allows the server to search the database for only selected product types and/or categories based on the shopper's selection. This step ensures that no extra time is wasted during further searching. As described above, a shopper may wish to bypass steps 804 and 808 by using the optional link 809. Additionally, after step 808, optional link 811 may be used to bypass the next filter step. Hereinafter, for purposes of completeness, it is assumed that the shopper wishes to apply all other filters rather than bypassing them using the optional links.

In step 812, a group filter is applied. In order to apply the group filter in step 812, the shopper must belong to at least one group. Using the feedback provided by other members of the shopper's group, relevant products are determined for the selected product. Typically a voting score is used from other members of the shopper's group. The voting score is a tally of match rank provided by members of the group. For example, if a group has ten members and they could vote on how well products went together, each member's vote is recorded and stored in the memory 112 and/or the database 114. The shopper may further filter the voting score by using only matching votes. Matching votes corresponds to votes from members of the group that match the shopper's own vote. Relevance will only be scored if the votes from the group matched the vote of the shopper. Otherwise, those votes will not count.

After the group filter is applied in step 812, a merchandiser filter is applied in step 816. The merchandiser filter uses information supplied by the manufacturer or vendor of a particular product to determine relevant products for the selected product. The manufacturer may have created a set of luggage and a purse to match. Therefore, if a shopper initially selected the purse and then the group filter was applied, the matching set of luggage would be relevant. Also the enterprise selling the products may input their definition of relevant products for use by the merchandiser filter.

After the merchandiser filter is applied in step 816, a brand filter is applied in step 820. The brand filter groups products that are in the same brand. For example, all Coach leather products would be relevant if the brand filter was applied to a selected Coach purse. Name brand products have become a status symbol and some individuals will only buy certain name brand products. A shopper can apply the group filter if they wish to have products from the same producer as the selected product.

After the brand filter is applied in step 820, a tag filter is applied in step 824. As described above, the tag filter uses keywords created by shoppers that describe attributes of certain product. The shopper can label their initially selected product as “suede” and “cowboy”. Then, after the tag filter is applied, relevant products will also have tags that relate to “suede” and/or “cowboy.” Additionally, tag filters may include trend filters. Trend filters are groups of tags created by shoppers and/or the enterprise that describe a matching fashion trend. One trend may be “Bohemian” and this trend may include the tag “suede”. Another trend may be “Western” and this trend may include both “suede” and “cowboy.” Relevant products can be determined based upon tags, trends or lifestyles as applied by the tag filter in step 824. In addition, geocoded data may also be used (like tags) in the tag filter step 824. This way tags, trends, lifestyles, and geocoded data are used as attributes of products in order to determine the product's relevance using the tag filter.

In step 828 a class filter is applied. The class filter will determine the relevance of products depending on what group of brands they belong to. Different types of brand classes include luxury brands, designer brands, value brands, and the like. A shopper may be interested in only high-end designer brand shoes. In this case, the shopper would selectively filter out all shoes except designer shoes. Other shoes that are designer brand would earn the highest relevance to the selected product.

In step 832 a color filter is applied. The color filter determines relevant products based on color. For example, if the shopper wants a matching product for the one that is already selected then a matching color filter is applied. Alternatively, the shopper may want complimentary colors to coordinate with the selected product. The shopper may also choose to have clashing colors. The most relevant products would be the ones with the corresponding desired colors.

In step 836 a material filter is applied. Both the material filter of step 836 and the color filter of step 832 are very similar to the tag filter that was applied in step 824 with the exception that no tags have to be applied to any products in order to perform steps 832 or 836, whereas at least one product must have a tag associated with it in order to perform step 824. The material filter of step 836 determines relevant products based on the type of materials they are made of (e.g., leather, suede, plastic, cotton, nylon, etc.) Once the desired filters have been applied in steps 804, 808, 812, 816, 820, 824, 828, 832, and 836 the most relevant products as compared to the selected product are determined. In order to determine the most relevant products, filters are applied and products are analyzed for the most matching attributes, in accordance with embodiments of the present invention. The product type and/or category filter is applied in order to minimize the number of products that are reviewed for their relevance. These two filters actually eliminate products from the rest of the relevance search. The other filters apply weight based scoring to all remaining products in order to determine the most relevant product. For example, to apply a weight-based determination of relevance by applying the tag filter, the number of matching tags is applied by a weighted coefficient. An overall equation can be applied in the following fashion to determine the relevance of each product as compared to the selected product. The variable Yᵢ will be used to determine whether or not a particular filter (i) is used. Yᵢ is a binary variable where Yᵢ equals one if filter (i) is used and equals zero if filter (i) is not used. Mᵢ is a variable representing the number of matches a particular product has based upon the filter that was applied. For example, if the tag filter (i=tag) is applied and the tag used to describe the selected product was used 20 times to describe a second product. M_{tag} of the second product is 20. Wᵢ is the weight that is applied to a particular filter. Some filters may be more heavily weighted than others, depending upon importance, and characteristics of the shopper. Each filter's weighted relevance is summed together where there are N (wherein N is an integer) total filters. To determine the relevance of any given product the following equation is applied.

$$relevance = {\sum }_{i = 1}^{N} {Y}_{i} {M}_{i} {W}_{i}$$

In accordance with embodiments of the present invention, the relevance of every candidate product is determined. Thereafter the most relevant products are determined in step 840 as the products having the highest relevance score. The most relevant products are displayed next to the initially selected product in step 844 in order for the shopper to see how they may go together. The product with the highest relevance score will be displayed first (i.e., at the top of the user device's 104 display). The product with the next highest relevance score is displayed second (i.e., below the first product) and so forth. Thereafter, if it is determined that the shopper would like to provide feedback in step 848, the shopper may input feedback regarding either the selected product, the other relevant product, or the how the products go together to make an ensemble in step 852. Then if it is determined that the shopper wishes to purchase any of the items in step 856, the transaction is completed in step 860. The behaviors and actions are recorded by the server 108 as described above then the method ends at step 868.

In accordance with embodiments of the present invention, filters are applied in three levels. In the first level, product type and category filters are applied in order to eliminate products from the relevance search. This creates a more manageable list of candidate products to search. In the second level, the filters that apply only to the products are applied. For instance, the merchandiser filter, brand filter, and class filter are applied in order to determine what products are more relevant. In the third layer, filters associated with customer's preferences and groups are applied. This layer fine tunes the grouping and relevance of each product based on the shoppers characteristics and groups that they belong to. One skilled in the art will also appreciate that at each layer a minimal cut can be made in order to speed up the relevance determination process. For example, assume that initially there are 100 products to choose from. After the first level of filtering is applied 50 of the original 100 products are eliminated. This means that only 50 products need to have their weighted relevance scores determined in the second level. After all of the 50 products have had their relevance calculated, a threshold score can be used to eliminate more products. For instance, the top 20 highest scoring products after the second level filter was applied may be admitted on to the third layer filter. The threshold could also be based upon top percentile or any products having a relevance score lower than a raw number may be eliminated from continuing. Again the number of products whose weighted relevance needs to be calculated is reduced. The remaining products have their relevance weighted in the third layer where the final relevance of each product is determined and the most relevant product is displayed first next to the selected product. The results of each cut along with the weighted relevance scores are also displayed to the shopper in case they would like to see how various products were scored. The weights of each filter can be varied by the shopper or the enterprise if it is determined that relevant products were cut prematurely.

As can be appreciated, the ongoing collection of customer information becomes a valuable asset. The ability to record and determine shopper characteristics allows an enterprise to customize a shopper's experience while visiting the enterprise's Internet e-commerce site. Every time a customer returns to a given Internet e-commerce site, more information is known about that shopper. The server 108 can gather previously recorded information from the database 114 and/or memory 112 and can then recall all of the attributes and behaviors of a particular shopper. The recalled information can be used to customize the products that the shopper views. Additionally, the enterprise can sell advertising space on their Internet e-commerce site in a customized fashion. The enterprise can sell focused advertisements to selected shoppers based on the shopper's determined and stored characteristics. For example, one shopper may be categorized as a “Cowboy” based on previous data gathered from his previous visits. As this shopper navigates around the Internet e-commerce site the advertisements displayed to him are related to products and services that a “Cowboy” might enjoy (e.g., truck advertisements, leather shops, horse boarding, etc.) Another shopper might be categorized as an “Urbanite”. This shopper would be shown different advertisements than the “Cowboy” would see. Advertisement space could be sold at a premium because the company advertising would know that their advertisements are reaching potentially interested customers, instead of being wasted on non-interested customers.

In addition to selling advertisement space to companies, an enterprise managing an Internet e-commerce site may put shoppers directly in contact with other companies based upon their characteristics. In accordance with one embodiment of the present invention, the enterprise has collected information relating to the characteristics of a given shopper. As that shopper navigates their Internet e-commerce site, the shopper may be asked if they would like to be put in contact with other vendors of products that they might like. In the same way advertising was customized for a particular shopper, contacts between the shopper and another vendor could be customized. The shopper would be selectively connected with vendors that they might have an interest in, and not other vendors whose products don't appeal to the group or category that the shopper belongs to. Potential vendors are identified for a given shopper based on their characteristics then the shopper is either shown an advertisement from that potential vendor, or is placed in contact with that vendor. As can be appreciated, more than one advertisement could be sold and displayed on a given Internet e-commerce site. Additionally, shoppers may select whether or not they wish to be connected with a particular vendor. Directed advertising can be presented to shoppers that are a member of a certain group or having certain determined characteristics. Links may also be provided to these shoppers that lead to retailers offering products or services in given areas of interest, including automobiles, investing, horoscopes, daycares/babysitters, vacations sites, travel agents, etc. The links are presented to shoppers only if it is determined that the shopper may be interested in the retailer's products or services based upon information gathered from the shopper during previous visits.

Some Internet e-commerce sites are able to customize advertisement space based on keywords and clicks that are recorded during a single visit. However, these sites do not continually gather and process information related to customers characteristics in order to group and categorize different customers. In accordance with embodiments of the present invention, information determined about a shopper during a previous Internet e-commerce site visit is used to identify relevant products and vendors of products. The information is then used to determine what type of advertisement(s) to display to them during a later visit to the same site.

An illustrative example of the invention will be discussed in accordance with embodiments of the present invention. There are four shoppers: Amy, Bob, Dina, and Emily. Each of these shoppers have different attributes and behaviors. Amy is a lawyer that goes on three or more business trips per month and two vacations per year. Bob is a teacher who goes on three vacations per year. Dina is an accountant and no other profile information is available. Emily is a flight attendant and in previous trips to the Internet e-commerce site she has indicated that her favorite shoes are shoes 3 and 4. The occupations and frequency of travel are attributes for each of these shoppers, whereas the voting history of Emily is a behavior that has been recorded by the server. There exists several shopping groups including professionals, academics, road warriors, vacation travelers, Trendsetters, and High Heel Highness. The professional group has members that are lawyers, accountants, doctors, etc. Therefore Amy and Dina are both a part of the professional group. Academics have members that are either students or teachers. Bob is a member of the Academics group. Road warriors have members that travel on more than two business trips per month. Emily and Amy are both a part of the road warriors group. Vacation travelers have members that go on at least one vacation per year. Amy and Bob are members of the vacation travelers group. The trendsetters group has members that purchase items from the more popular trends. The high heel highness group has members that own more than two pairs of high heels. The trendsetters and high heel highness groups are defined by behaviors logged by the server, whereas the other groups are generally defined by attributes of shoppers. There are four bags, four shoes, and three shoes ensembles.

Amy browses the Internet e-commerce site and finds Bag 1 and creates the following tags to describe Bag 1; “pink”, “handbag”, and “leather”. Amy then tags Bag 3 with “handbag”, “leather”, and “great for a first date”. To view other pink handbags, Amy (or any other shopper) clicks on the “pink” tag hyperlink and sees Bag 1, and has the option of seeing all other bags previously tagged “pink” by her and other shoppers. The group of pink bags is displayed in a list sorted in order, where the bag that has been tagged “pink” the most is at top and the bag that has been tagged “pink” the least is at the bottom. The list can be re-ordered according to various characteristics that Amy chooses. For example, she can select a hyperlink associated with her occupation “lawyer”, and the list is sorted according to other lawyers that have tagged bags as “pink”. Ensembles and lists can be sorted according to tags and characteristics of people who have tagged those items.

In another example, Amy has purchased several pairs of high heel shoes, and through these actions her behaviors have been updated to reflect the same. This behavior of buying several high heel shoes associates her with the shopper group “High Heel Highness”. Dina has chosen to belong to the shopper group “High Heel Highness”. Through this shopper group Dina has access to several trends set up by other shoppers (members) of this group. Dina selects a trend named “High Heels for Comfort” and is presented with a group of items that several members of her group have selected and recommended. Dina is further able to refine her selection to shoe 4, by clicking on one or a number of tags like “3 inch heels”, “powder blue”, and/or “leather” that other members of the group have created and associated with the previously selected trend. One shopper (Dina) is able to benefit from a number of other opinions offered by the members of the group “High Heel Highness”.

In addition to receiving shopper feedback on an Internet e-commerce site, many of the same steps and concepts described above can be administered through surveys sent directly to shoppers. For example, email surveys can be sent to shoppers to gain feedback on new items and ensembles. In order to receive surveys, shoppers enroll in the survey program on the Internet e-commerce site. Once enrolled, the shoppers may receive surveys on a periodic (e.g., monthly, weekly, or any time a new product line comes out) to receive feedback on the items. As shoppers complete surveys their characteristics will be updated. The behavior of a shopper is recorded and updated by the server 108 according to answers provided on the surveys. For example, shoppers that provide positive feedback on items and ensembles related to the latest styles may eventually be categorized as “Trendy”. Other shoppers that do not show as much enthusiasm about the latest styles may be in a more traditional category or group. The server 108 stores this information so that the next time a given shopper visits the Internet e-commerce site, the behavior of the shopper is updated and items/ensembles displayed to the shopper are customized accordingly. Also, future email surveys can be targeted at shoppers that will provide more constructive feedback on a given item, set of items and/or ensembles. For instance, surveys relating to the next style are sent to shoppers that are a part of the “Trendy” group. Surveys relating to more traditional styles are sent to shoppers belonging to the “Classic” group.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described herein above are further intended to explain the best mode presently known of practicing the invention and to enable others skilled in the art to utilize the invention in such or in other embodiments and with the various modifications required by their particular application or use of the invention. It is intended that the appended claims be construed to include alternative embodiments to the extent permitted by the prior art.

What is claimed is:

1. A method for coordinating manufactured goods for display as ensembles on an e-commerce site, comprising:
providing a first set of items;
determining certain criteria about a first and second shopper;
receiving feedback from the first shopper relating to at least one item in the first set of items;
in response to receiving feedback from the first shopper, creating a second set of items comprising a subset of the first set of items; and
displaying at least one item from the second set of items to the second shopper in response to determining that the certain criteria of the first and second shopper are similar.

2. The method of claim 1, wherein the feedback is received in the form of a tag created by the first shopper.

3. The method of claim 1, wherein the similar certain criteria between the first and second shopper are at least one of age, gender, occupation, family information, recreational activities, and marital status.

4. The method of claim 1, further comprising receiving feedback from the second shopper relating to the at least one item from the second set of items, and in response to receiving feedback from the second shopper, creating a third set of items comprising a subset of the second set of items.

5. The method of claim 1, wherein the second set of items is displayed to the second shopper in the form of an ordered list.

6. The method of claim 5, wherein a most relevant item is displayed at the top of the ordered list and the next most relevant item is displayed below the most relevant item.

7. The method of claim 1, wherein the similar certain criteria between the first and second shopper are determined by a behavior of the first and second shopper.

8. The method of claim 7, wherein the behavior is at least one of previous votes logged relating to items, previous items purchased, previous item ratings, testimonials, blog entries, and previous tags created.

9. The method of claim 1, further comprising displaying the first set of items substantially adjacent to the second set of items.

10. A method for creating an ensemble of consumer goods or information to be displayed on an e-commerce site, comprising:
receiving a request to display a first product;
determining attributes of the first product;
in response to receiving the request, displaying the first product to a shopper;
from a first set of candidate products, finding a most relevant product, wherein the most relevant product has more attributes in common with the first product than any other product from the first set of candidate products; and
displaying the most relevant product with the first product.

11. The method of claim 10, wherein finding the most relevant product further comprises applying at least a first level filter to the first set of candidate products, and in response to applying the at least a first level filter creating a second set of candidate products.

12. The method of claim 11, wherein a number of products in the second set of candidate products is less than a number of products in the first set of candidate products.

13. The method of claim 11, wherein the first level filter is at least one of an expected product type filter, an expected product category filter, a merchandiser filter, a brand filter, a tag filter, a trend filter, a geocoded data filter, a class filter, a color filter, a material filter, and a group filter.

14. The method of claim 13, wherein the at least one filter is the expected product type filter and the expected product category filter.

15. The method of claim 13, wherein a weighted relevance of each at least one filter applied is summed in order to determine a relevance for each product of the first set of candidate products.

16. The method of claim 15, wherein the most relevant product has a greater summed weighted relevance than all other products of the first set of candidate products.

17. The method of claim 11, further comprising applying at least a second level filter to the second set of candidate products and in response to applying the at least a first second filter, creating a third set of candidate products.

18. The method of claim 10, wherein finding a most relevant product includes finding one or more relevant products.

19. A method for assembling one or more goods for purchase on an e-commerce site, comprising:
providing a first and second group of products and at least one customer feedback mechanism including questions related to at least one of the first and second group of products;
receiving feedback from the at least one customer feedback mechanism;
based upon received feedback, creating a hierarchy of customer preferences of products in at least one of the first and second group of products;
organizing at least one of the first and second group of products according to the hierarchy; and
displaying the organized first and second group of products.

20. The method of claim 19, wherein the customer feedback mechanism is a survey.

21. The method of claim 20, wherein the survey is administered by email.

22. The method of claim 19, wherein feedback is received in a form of a tag, said tag being applied to at least one product in the first and second group of products.

23. The method of claim 19, wherein the customer preferences are based on at least one of color, class, material, preference, location, taste, tags, trends, and lifestyles.

24. The method of claim 19, wherein the organization of the at least one of the first and second group of products is based upon a weighted relevance of the hierarchy of customer preferences of products in the first and second group of products.
